(19) United States
(12) Patent Application Publication
(10) Pub. No.: US 2022/0101390 A1
(43) Pub. Date: Mar. 31, 2022

(54) TIME DONATION BANK PLATFORM AND TIME DONATION METHOD USING PLATFORM

(71) Applicant: Heon Hong KIM, Gyeonggi-do (KR)

(72) Inventor: Heon Hong KIM, Gyeonggi-do (KR)

(21) Appl. No.: 17/425,594

(22) PCT Filed: Jan. 22, 2020
(86) PCT No.: PCT/KR2020/001121

§ 371 Date: Jul. 23, 2021

(30) Foreign Application Priority Data
Jan. 24, 2019 (KR) 10-2019-0009224

(51) Int. Cl. G06Q 30/02; G06Q 20/10; G06Q 50/22

(52) U.S. Cl. CPC G06Q 30/0279; G06Q 50/22; G06Q 20/10

(57) ABSTRACT

A time donation bank platform according to an embodiment of the present disclosure has a structure in which technology is implemented so that a demander providing the paid volunteer job is linked with a performer who desires to meaningfully spend the time left after daily life, and the profits obtained from the link is donated at a predetermined rate, whereby the performer may receive a sense of mental satisfaction due to additional economic income and participation in donation activities, the demander may easily recruit a worker when necessary and at the same time is given pride in contributing to society, and a donation receiver may receive a donation to use for the socially disadvantaged.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2020/001121, filed Jan. 22, 2020, which claims priority to the benefit of Korean Patent Application No. 10-2019-0009224 filed in the Korean Intellectual Property Office on Jan. 24, 2019, the entire contents of which are incorporated herein by reference.

### BACKGROUND

### 1. Technical Field

The present invention relate to time-sharing platform technology that generates social value by linking wasted spare time of a member of a community and a paid volunteer job (e.g., small task, normal task, and expert task) and, more particularly, to a time donation bank platform and a time donation method using the platform having a structure in which technology is implemented so that a demander providing the paid volunteer job is linked with a performer who desires to meaningfully spend the time left after daily life, and the profits obtained from the link is donated at a predetermined rate, whereby the performer may receive a sense of mental satisfaction due to additional economic income and participation in donation activities, the demander may easily recruit a worker when necessary and at the same time is given pride in contributing to society, and a donation receiver may receive a donation to use for the socially disadvantaged.

### 2. Background Art

The level of domestic donation in South Korea is low compared to that of other OECD countries, and donation method is mainly conducted through donation organizations. However, due to opacity and corruption of the donation organizations, social demand for disclosure of donation usage is growing. The lack of leadership by example for the so-called noblesse oblige of social leaders is also negatively affecting the generation of a donation culture. In addition, as for volunteer activities in South Korea, the rate of volunteer activities obligatorily performed in schools by teenagers in elementary, middle, and high school is the highest level in the world, but the rate of volunteer activities performed by adults in their twenties and above shows a lower level than that of Europe or the United States. Since volunteer activities for teenagers are compulsory, volunteer activities are abused as a means of entering a higher school, so volunteer activities are performed by family members on behalf of their teens or service hours in volunteer activities are manipulated, thereby causing numerous harmful effects and diminishing the meaning of volunteer activities. Nevertheless, most people have a desire to contribute to the world. However, considering the fact that people may not participate in social volunteer activities for various reasons such as time, health, and economic leisure, it is necessary to provide a social structural system that allows each member of society to enjoy self-esteem by contributing to the society to which they belong.

Meanwhile, as a result of CSR (Corporate Social Responsibility) survey conducted on SMEs by Kodit (Korea Credit Guarantee Fund), 45.8% of respondents answered “very necessary” and 41.8% of respondents answered “somewhat necessary”, so that 87.6% of respondents in total answered that socially responsible management is necessary. Kodit analyzed these results and announced that “These are the results generated while the importance of CSR is spreading around the world, and the survey shows that perception of CSR of SMEs in South Korea is also changing.” As such, from consumers, environmental groups, and national governments, companies are under pressures and burdens, and take responsibilities for matters such as social responsibility and contribution, prohibition of labor exploitation, convenience and employment of the disabled, reduction of waste, environmental conservation, carbon dioxide reduction, and sustainable development. That is, company's social responsibility is becoming more and more important from a company standpoint, and various sustainability management reports including green growth and social contribution are being actively published. Companies that have only pursued corporate profits have no choice but to take an interest in corporate sustainable management, because companies have become interested in social marketing or cause marketing according to the improvement of civic awareness, and companies are aware of the need to contribute to society as well. Consequently, from the company's point of view, companies need a system that enables companies to participate in social donation activities at a low cost, provide a job to vulnerable groups such as the elderly, the disabled, housewives, youth, and multicultural families, and directly or indirectly support institutions or organizations, which are donation receivers in the local community.

### SUMMARY

As a result of numerous studies, the present inventor has completed the present invention by developing a time donation bank platform that enables everyone to contribute their spare time to themselves and society.

Accordingly, an objective of the present invention is to provide a time donation bank platform and a time donation method using the same, the platform and method linking a demander who provides a paid volunteer job (e.g., small task, normal task, and expert Task) and a performer who desires to use spare time thereof meaningfully after daily life and realizing donation of the profits obtained from the links at a predetermined rate, so as to generate economic income and donations for the performer, thereby realizing a sharing economy for time equally owned by all individuals.

Another objective of the present invention is to provide a time donation bank platform and a time donation method using the same, the platform and method enabling companies to indirectly participate in social donation generating activities at low cost, providing a paid volunteer job to vulnerable social groups such as the elderly, the disabled, housewives, youth, and multicultural families, and directly or indirectly supporting a donation receiver or a donation organization in a community, so that the platform and method are used as a means of cause marketing to promote and advertise the companies as socially responsible corporations.

Yet another objective of the present invention is to provide a time donation bank platform and a time donation method using the same, the platform and method promoting vitalization of local economy and strengthening of ties within a local community, helping maintain livelihood and social stability for the vulnerable social groups such as the elderly, the disabled, housewives, multicultural families, and youth, supporting healthy and vibrant communities by promoting psychological confidence, satisfaction, and self-esteem, and contributing to support social welfare policies of the central and local governments in each country.

The objectives of the present invention are not limited to the above-mentioned objectives, and even when not explicitly mentioned therein, it is apparent that the objectives of the invention that may be recognized by those skilled in the art may also be included from the description of the detailed specification of the present invention.

In order to achieve the objectives of the present invention described above, the present invention provides time donation bank platform including: a user account management module configured to generate a user account including a donation receiver account, a demander account, and a performer account according to user information input from a user terminal, and register and manage the user account in an account information DB; a worker request proposal management module configured to register and manage information related to a worker request proposal input from the demander account in a worker request proposal DB; a worker support proposal management module configured to register and manage information related to a worker support proposal input from the performer account in a worker support proposal DB; a worker match management module configured to analyze, compare, and process worker request proposal information registered in the worker request proposal DB and worker support proposal information registered in the worker support proposal DB so as to match each other with a worker match, respectively provide information related to the worker match to a corresponding demander account user terminal and performer account user terminal, take additional measures depending on whether the worker match is successful or not, and register and manage information obtained upon progress or completion of the worker match in a worker match DB; and a donation time distribution and management module configured to distribute a preset wage remitted from a specific demander account user according to donation-related information determined by a specific performer account user when worker execution information is input from one or more of a specific performer account and a specific demander account, the worker execution information indicating that the specific performer account user in response after the worker match performed by the worker match management module is successful has provided a worker to the specific demander account user, manage remittance to one or more of a corresponding financial institution of the specific performer account user, a corresponding financial institution of a donation receiver account user listed in the donation-related information, and a time donation bank (TDB) donation account, perform remittance management by transmitting financial transaction information for the remittance when the preset wage is remitted from a demander account user to cooperative financial institutions, the financial transaction information including amounts respectively distributed to the cooperative financial institutions at a predetermined rate according to the donation-related information and one or more pieces of the following information of financial institutions to which the distributed amounts is to be deposited: information of the corresponding financial institution of the performer account user, information of the corresponding financial institution of the donation receiver account user, and information of the TDB donation account, and generate, transmit, and manage worker execution completion information, new donation history information, and new job provision history information.

In a preferred exemplary embodiment, the time donation bank platform may further include: a donation history management module configured to receive the donation-related information from the performer account user, register the donation-related information in a lifetime history information DB corresponding to the performer account, receive the new donation history information, update and manage performer lifetime history information including the donation-related information and the new donation history information in the lifetime history information DB, receive the new job provision history information including job hours generated and the wage paid, by the demander account user, register the new job provision history information in the lifetime history information DB corresponding to the demander account, and update and manage demander lifetime history information including the job provision history information in the lifetime history information DB.

In the preferred exemplary embodiment, the time donation bank platform may further include: a donation receiver management module configured to register, in a donation receiver DB, basic information on a donation receiver that requests a donation input from the donation receiver account and donation request-related information including financial institution information of the donation receiver, and update and manage donation receiver information including the donation request-related information.

In the preferred exemplary embodiment, the donation-related information may include: donation rate information for the wage obtained when worker provision is completed; donation plan information including the donation receiver information; and one or more pieces of the following information of the financial institutions to which the amounts distributed according to the donation plan information is transferred: information of the performer account user, information of financial institution of the donation receiver account user, and information of the TDB donation account, the donation history information may include donation amount for each donation receiver and time donation history information in which support time of the performer account user up to the present time is converted into donation time for other people and donation time for oneself according to donation rate information, the support time of the performer account user may be provided with 2 dona (i.e., donations) per support hour each time when a piece of the worker execution completion information is registered in the worker match DB, the donation rate information may be able to determine rates such that a minimum donation rate is 5% of a wage and a maximum donation rate is 100% of the wage, and the time donation history information may be registered and managed cumulatively so that 2 dona is given per support hour for a piece of the registered worker execution completion information, all 2 dona are given to an item of the donation time for other people when the donation rate information has the maximum donation rate of 100%, and 1 dona is given to the item of the donation time for other people and 1 dona is given to an item of the donation time for oneself when the maximum donation rate is in a range from greater than or equal to 5% to less than 100%.

In the preferred exemplary embodiment, when confirmation document issuance request information for one's time donation activity is input from any one or more of the performer account and the demander account, a donation history management module may register the confirmation document issuance request information in a lifetime history information DB, search performer lifetime history information and demander lifetime history information of one or more of the specific performer account and the demander account corresponding to the confirmation document issuance request information, and transmit the confirmation document issuance request information to the searched specific donation receiver account, and when a confirmation document of service donation activity is input from the donation receiver account, the donation history management module may register the confirmation document in the lifetime history information DB, and transmit the confirmation document to the specific performer account and the demander account, to which the confirmation document issuance request information is input.

In the preferred exemplary embodiment, when a specific worker request proposal input from the specific demander account is registered in the worker request proposal DB by the worker request proposal management module, the worker match management module may search the worker support proposal DB for a progress of the worker match, and when there is the worker support proposal that satisfies a worker match condition of the specific worker request proposal, the worker match management module may transmit one or more appropriate worker support proposals to the specific demander account, determine the appropriate worker support proposal input from the specific demander account as an optimal worker support proposal, generate worker match reservation information in which the specific worker request proposal and the optimal worker support proposal are paired, register the worker match reservation information in the worker match DB, and then transmit the worker match reservation information to the specific demander account and the specific performer account to which the optimal worker support proposal is input.

When a specific worker support proposal input from the specific performer account is registered in the worker support proposal DB by the worker support proposal management module, the worker match management module may search the worker request proposal DB for the progress of the worker match, and when there is the worker request proposal that satisfies the worker match condition of the specific worker support proposal, the worker match management module may transmit one or more appropriate worker request proposals to the specific performer account, determine the appropriate worker request proposal input from the specific performer account as an optimal worker request proposal, generate the worker match reservation information in which the specific worker support proposal and the optimal worker request proposal are paired, registers the worker match reservation information in the worker match DB, and then transmit the worker match reservation information to the specific performer account and the specific demanding party account to which the optimal worker request proposal is input.

When the worker match reservation information is transmitted to the specific demander account and the specific performer account by the worker match management module, the worker match management module may respectively attach worker match reservation tags to the specific worker request proposal and the optimal worker support proposal or the specific worker support proposal and the optimal worker request proposal, which constitute the worker match reservation information, by the worker request proposal management module and the worker support proposal management module to modify and register the proposals in the worker request proposal DB and the worker support proposal DB.

In the preferred exemplary embodiment, when a wage deposit signal in which the wage included in a specific worker request proposal is deposited within a preset time is input from the specific demander account to which worker match reservation information is transmitted, the worker match management module may generate worker match success information, registers the worker match success information in the worker match DB, and then transmit the worker match success information to the specific demander account and the specific performer account, and the worker match reservation tags respectively attached to the specific worker request proposal and the optimal worker support proposal or a specific worker support proposal and an optimal worker request proposal, which constitute the worker match success information, may be changed to worker match success tags, by the worker request proposal management module and the worker support proposal management module, and modified and registered in the worker request proposal DB and the worker support proposal DB.

In the preferred exemplary embodiment, when a wage deposit signal in which the wage included in a specific worker request proposal is deposited within a preset time is not input from the specific demander account to which worker match reservation information is transmitted, the worker match management module may generate worker match failure information, registers the worker match failure information in the worker match DB, and then transmit the worker match failure information to the specific demander account and the specific performer account, and the worker match reservation tags respectively attached to the specific worker request proposal and an optimal worker support proposal or a specific worker support proposal and an optimal worker request proposal, which constitute the worker match failure information, may be changed to worker match failure tags, by the worker request proposal management module and the worker support proposal management module, and modified and registered in the worker request proposal DB and the worker support proposal DB.

In the preferred exemplary embodiment, when the worker match reservation tag is changed to the worker match failure tag and registered in the worker request proposal DB and the worker support proposal DB, the matching each other with the worker match may be re-performed, by the worker match management module for the specific worker request proposal or the specific worker support proposal, which constitute the worker match failure information.

In the preferred exemplary embodiment, when the worker support proposal that satisfies a worker match condition of a specific worker request proposal input from the specific demander account does not exist in the worker support proposal DB, the worker match management module may transmit a modification proposal recommendation message for the worker match condition of the specific worker request proposal to the specific demander account, or when the worker request proposal that satisfies the worker match condition of a specific worker support proposal input from the specific performer account does not exist in the worker request proposal DB, the worker match management module may transmit a modification proposal recommendation message for the worker match condition of the specific worker support proposal to the specific performer account.

In the preferred exemplary embodiment, when performer lifetime history information and demander lifetime history information registered in a lifetime history information DB are updated, a donation history management module may transmit the updated performer lifetime history information and demander lifetime history information to the corresponding performer account and demander account.

In addition, the present invention provides a time donation method including: generating an account, wherein a user account including a donation receiver account, a demander account, and a performer account is generated according to user information input from a user terminal by a user account management module, and registered in an account information DB; determining a donation, wherein donation-related information input from the performer account is registered in a lifetime history information DB corresponding to the performer account by a donation history management module; requesting a worker, wherein information related to a worker request proposal input from the demander account is registered in a worker request proposal DB by a worker request proposal management module; supporting the worker, wherein information related to a worker support proposal input from the performer account is registered in a worker support proposal DB by a worker support proposal management module; matching the worker, wherein worker request proposal information registered in the worker request proposal DB and worker support proposal information registered in the worker support proposal DB are analyzed, compared, and processed by a worker match management module to match each other with a worker match whenever the worker request proposal is registered in the worker request proposal DB or the worker support proposal is registered in the worker support proposal DB; notifying the worker match, wherein worker match success information or worker match failure information each registered in a worker match DB is transmitted to a corresponding specific performer account and a specific demander account after the worker match success information is registered in the worker match DB when the worker match is successful, and the worker match failure information is registered in the worker match DB when the worker match has failed by the worker match management module; and executing the donation, wherein remittance to one or more of a corresponding financial institution of a specific performer account user, a corresponding financial institution of a donation receiver account user listed in the donation-related information, and a TDB donation account is managed by distributing a preset wage remitted from a specific demander account user by a donation time distribution and the management module according to the donation-related information input by the specific performer account user when worker execution information indicating that the specific performer account user has provided the worker to the specific demander account user is input from one or more of the specific demander account and the specific performer account to which the worker match information is transmitted, and remittance management is performed by transmitting financial transaction information for remittance when the preset wage is remitted from the demander account user to the cooperative financial institutions, the financial transaction information including amounts distributed to cooperative financial institutions at a predetermined rate according to the donation-related information and one or more pieces of the following information of financial institutions to which the distributed amounts is to be deposited: information of the corresponding financial institution of the performer account user, information of the corresponding financial institution of the donation receiver account user, and information of the TDB donation account.

In a preferred exemplary embodiment, the time donation method may further include: receiving new donation history information and the new job provision history information generated by the donation time distribution and management module in the executing of the donation; generating, by the donation history management module, time donation history information in which support time of the specific performer account user is converted into donation time for other people and donation time for oneself according to the new donation history information, generating new performer lifetime history information including donation amount accumulated up to the present time and the time donation history information for each donation receiver, or generating demander lifetime history information of the specific demander account user according to the new job provision history information; and managing donation history, the managing of the donation history including updating, by the donation history management module, the generated performer lifetime history information and the demander lifetime history information in the lifetime history information DB and transmitting the modified lifetime history information to the specific performer account and the demander account.

In the preferred exemplary embodiment, the matching of the worker may include: comparing and analyzing whether or not there is the worker support proposal that satisfies a worker match condition of a specific worker request proposal by searching the worker support proposal DB by the worker match management module when the specific worker request proposal input from the specific demander account by the worker request proposal management module is registered in the worker request proposal DB; transmitting one or more appropriate worker support proposals that satisfies the worker match condition to the specific demander account by the worker match management module; and determining an appropriate worker support proposal input from the specific demander account as an optimal worker support proposal by the worker match management module, generating the worker match reservation information in which the specific worker request proposal and the optimal worker support proposal are paired, registering the worker match reservation information in the worker match DB, and then transmitting the worker match reservation information to the specific demander account and the specific performer account to which the optimal worker support proposal is input, or the matching of the worker may include: comparing and analyzing whether or not there is the worker request proposal that satisfies the worker match condition of a specific worker support proposal by searching the worker request proposal DB by the worker match management module when the specific worker support proposal input from the specific performer account by the worker support proposal management module is registered in the worker support proposal DB; transmitting one or more appropriate worker request proposals that satisfies the worker match condition to the specific performer account by the worker match management module; and determining an appropriate worker request proposal input from the specific performer account as an optimal worker request proposal by the worker match management module, generating worker match reservation information in which the specific worker support proposal and the optimal worker request proposal are paired, registering the worker match reservation information in the worker match DB, and then transmitting the worker match reservation information to the specific performer account and the specific demander account to which the optimal worker request proposal is input, and the matching of the worker may further include: attaching a worker match reservation tag, by the worker request proposal management module and the worker support proposal management module, to the specific worker request proposal and the optimal worker support proposal or the specific worker support proposal and the optimal worker request proposal, which constitute the worker match reservation information transmitted to the specific demander account and the specific performer account; and modifying and registering the proposals in the worker request proposal DB and the worker support proposal DB.

In the preferred exemplary embodiment, the donation-related information may include: donation rate information for the wage obtained when worker provision is completed; donation plan information including donation receiver information; and one or more pieces of information of the financial institutions to which the amounts distributed according to the donation plan information is transferred: information of the performer account user, information of the financial institution of the donation receiver account user, and information of the TDB donation account, donation history information may include donation amount for each donation receiver and time donation history information in which support time of the performer account user up to the present time is converted into donation time for other people and donation time for oneself according to the donation rate information, the support time of the performer account user may be provided with 2 dona per support hour each time when a piece of worker execution completion information is registered in the worker match DB, the donation rate information may be able to determine rates such that a minimum donation rate is 5% of a wage and a maximum donation rate is 100% of the wage, and the time donation history information may be registered and managed cumulatively so that 2 dona is given per support hour for a piece of the registered worker execution completion information, all 2 dona are given to an item of donation time for other people when the donation rate information has the maximum donation rate of 100%, and 1 dona is given to the item of donation time for other people and 1 dona is given to an item of donation time for oneself when the maximum donation rate is in a range from greater than or equal to 5% to less than 100%.

In the preferred exemplary embodiment, the time donation method may further include: issuing a donation confirmation document including: registering, by the donation history management module, confirmation document issuance request information in the lifetime history information DB according to the confirmation document issuance request information for time donation activity input from any one or more of the performer account and the demander account; searching, by the donation history management module, performer lifetime history information and demander lifetime history information of one or more of the specific performer account and demander account corresponding to the confirmation document issuance request information, and transmitting the confirmation document issuance request information to the searched specific donation receiver account; and registering, by the donation history management module, a confirmation document of the time donation activity in the lifetime history information DB when the confirmation document of the time donation activity is input from the donation receiver account, and then transmitting the confirmation document issuance request information to the specific performer account and demander account to which the information is input.

In the preferred exemplary embodiment, the notifying of the worker match may include: generating the worker match success information, registering the worker match success information in the worker match DB when a wage deposit signal in which a wage included in a specific worker request proposal is deposited within a preset time is input from the specific demander account to which the worker match management module has transmitted worker match reservation information, and transmitting the worker match success information to the specific demander account and the specific performer account; and changing, to a worker match success tag, a worker match reservation tag attached to each of proposals including the specific worker request proposal and an optimal worker support proposal or a specific worker support proposal and an optimal worker request proposal, which constitute the worker match success information, and modifying and registering the proposals in the worker request proposal DB and the worker support proposal DB, respectively, or the notifying of the worker match may include: generating the worker match failure information, registering the worker match failure information in the worker match DB when the wage deposit signal in which the wage included in the specific worker request proposal is deposited within the preset time is not input from the specific demander account to which the worker match management module has transmitted the worker match reservation information, and transmitting the worker match failure information to the specific demander account and the specific performer account; and changing, to a worker match failure tag, the worker match reservation tag attached to each of proposals including the specific worker request proposal and the optimal worker support proposal or the specific worker support proposal and the optimal worker request proposal, which constitute the worker match failure information, and modifying and registering the proposals in the worker request proposal DB and the worker support proposal DB, respectively.

In the preferred exemplary embodiment, when the worker match reservation tag is changed to the worker match failure tag by the worker request proposal management module and the worker support proposal management module and is modified and registered in the worker request proposal DB and the worker support proposal DB, the matching of the worker may be re-performed for the specific worker request proposal or the specific worker support proposal, which constitute the worker match failure information.

In the preferred exemplary embodiment, the matching of the worker may further include transmitting a modification proposal recommendation message for a worker match condition of a specific worker request proposal to the specific demander account by the worker match management module when the worker support proposal that satisfies the worker match condition of the specific worker request proposal input from the specific demander account does not exist in the worker support proposal DB, or transmitting the modification proposal recommendation message for the worker match condition of a specific worker support proposal to the specific performer account by the worker match management module when a worker request proposal that satisfies the worker match condition of the specific worker support proposal input from the specific performer account does not exist in the worker request proposal DB.

In addition, the present invention provides an application for time donation activity of any one of claims 1 to 3, wherein the application for the time donation activity is installed on a user terminal connected to any time donation bank platform described above in order for time donation activity information of an account user generated in the time donation bank platform to be transmittable in both directions, whereby the application for the time donation activity is executed so that the account user is able to recognize input and output of the time donation activity information, the input and output being performed through the time donation bank platform.

In a preferred exemplary embodiment, the user terminal may be any one of a PC, a laptop computer, a smart phone, and a tablet.

According to the present invention described above, the following effects may be obtained.

First, the present invention links a demander who provides a paid volunteer job (e.g., small task, normal task, and expert task) and a performer who desires to use spare time thereof meaningfully after daily life and realizes donation of the profits obtained from the links at a predetermined rate, so as to generate economic income and donations for the performer, thereby realizing a sharing economy for time equally owned by all individuals.

In addition, the present invention enables companies to indirectly participate in social donation generating activities at low cost, provide a paid volunteer job to vulnerable social groups such as the elderly, the disabled, housewives, youth, and multicultural families, and indirectly support a donation receiver or a donation organization in a community, thereby providing cause marketing and conveying good will to promote and advertise the companies as socially responsible corporations.

In addition, the present invention may promote vitalization of local economy and strengthening of ties within a local community, help maintain livelihood and social stability for the vulnerable social groups such as the elderly, the disabled, housewives, multicultural families, and youth, support healthy and vibrant communities by promoting psychological confidence, satisfaction, and self-esteem, and contribute to support social welfare policies of the central and local governments in each country.

Such technical effects of the present invention are not limited only to the range mentioned above, and even when not explicitly mentioned therein, it is apparent that the effects of the invention that may be recognized by those skilled in the art are also included from the description of the detailed specification of the invention described below.

### BRIEF DESCRIPTION OF THE DRAWINGS

FIG. 1 is a block diagram showing a schematic configuration of a time donation bank platform according to an exemplary embodiment of the present invention.

FIG. 2 is a flowchart showing a process that is performed when donation-related information is determined and registered by a performer account user in the time donation bank platform shown in FIG. 1.

FIG. 3 is a flowchart showing a process in which matching a worker is performed after new worker request proposal information is registered in the time donation bank platform shown in FIG. 1.

FIG. 4 is a flowchart showing a process in which the matching of the worker is performed after new worker support proposal information is registered in the time donation bank platform shown in FIG. 1.

FIG. 5 is a flowchart showing a process in which notifying a worker match is performed when a worker match is successful in accordance with new worker match reservation information registered according to FIGS. 3 and 4.

FIG. 6a is a flowchart showing a process in which the notifying of the worker match is performed when the worker match has failed according to the new worker match reservation information registered according to FIGS. 3 and 4. FIG. 6b is a flowchart showing a process in which the matching of the worker is performed after worker match failure information is registered according to FIG. 6a, treated as new worker request proposal information in the same manner as in FIG. 3, and registered as second new worker match reservation information. FIG. 6c is a flowchart showing a process in which the matching of the worker is performed after the worker match failure information is registered according to FIG. 6a, treated as new worker support proposal information in the same manner as in FIG. 4, and registered as second new worker match reservation information.

FIG. 7 is a flowchart showing a process in which executing a donation is performed after executing the worker is completed in accordance with worker match success information transmitted from FIG. 5.

FIG. 8 is a flowchart showing a process in which managing donation history is performed after the executing of the donation is completed in FIG. 7.

FIG. 9 is a flowchart showing a process in which issuing a donation confirmation document is performed upon a request based on the donation-related information registered corresponding to a performer account when the donation is executed.

### DETAILED DESCRIPTION

The terminology used herein is for the purpose of describing particular exemplary embodiments only and is not intended to be limiting. As used herein, the singular forms are intended to include the plural forms as well, unless the context clearly indicates otherwise. In the present disclosure, it will be understood that the terms “comprise”, “include”, “have”, etc., when used in this specification, specify the presence of stated features, integers, steps, operations, elements, components, and/or combinations of them, but do not preclude the presence or addition of one or more other features, integers, steps, operations, elements, components, and/or combinations thereof.

It will be understood that, although the terms “first”, “second”, etc. may be used herein to describe various elements, these elements should not be limited by these terms. These terms are only used for the purpose of distinguishing one element from another element. For example, the first element may be referred to as a second element without departing from the scope of the present invention, and similarly, the second element may be referred to as a first element.

Unless otherwise defined, all terms including technical and scientific terms used herein have the same meaning as commonly understood by those skilled in the art to which the present invention belongs. It will be further understood that terms as defined in dictionaries commonly used herein should be interpreted as having a meaning that is consistent with their meaning in the context of this specification and the relevant art and will not be interpreted in an idealized or overly formal sense unless expressly so defined herein.

When the relation of a time sequential order is described using the terms such as “after”, “continuously to”, “next to”, and “before”, the order may not be continuous unless the terms are used with the term “immediately” or “directly”.

Hereinafter, a technical configuration of the present invention will be described in detail with reference to the accompanying drawings and preferred exemplary embodiments.

However, the present invention is not limited to the exemplary embodiments described herein and may be embodied in other forms. The same reference numerals used to describe the present invention throughout the specification indicate the same components.

The technical features of the present invention are in a time donation bank (TDB) platform and a time donation method using the same, the platform and method linking a demander who provides a paid volunteer job (e.g., small task, normal task, and expert task) and a performer who desires to use spare time thereof meaningfully after daily life and realizing donation of the profits obtained from the links at a predetermined rate, so as to generate economic income and donations for the performers, thereby realizing a sharing economy for time equally owned by all individuals.

Accordingly, the time donation bank platform of the present invention includes: a user account management module configured to generate a user account of any one of a donation receiver account, a demander account, and a performer account according to user information input from a user terminal, and register and manage the user account in an account information DB; a worker request proposal management module configured to register and manage information related to a worker request proposal input from the demander account in a worker request proposal DB; a worker support proposal management module configured to register and manage information related to a worker support proposal input from the performer account in a worker support proposal DB; a worker match management module configured to analyze, compare, and process worker request proposal information registered in the worker request proposal DB and worker support proposal information registered in the worker support proposal DB so as to match each other with a worker match, respectively provide information related to the worker match to the corresponding user terminals of the demander account and performer account, take additional measures depending on whether the worker match is successful or not, and register and manage the information obtained upon progress or completion of the worker match in a worker match DB; and a donation time distribution and management module configured to distribute a preset wage remitted from a specific demander account user according to donation-related information determined by a specific performer account user when the worker execution information is input from one or more of the specific performer account and the specific demander account, the worker execution information indicating that the specific performer account user corresponding after the worker match performed by the worker match management module is successful has provided a worker to the specific demander account user, manage remittance to one or more of a corresponding financial institution of the specific performer account user, a corresponding financial institution of a donation receiver account user listed in the donation-related information, and a time donation bank (TDB) donation account, and generate, transmit, and manage the worker execution completion information, new donation history information, and new job provision history information.

In addition, the time donation method of the present invention includes: generating an account, wherein any one of a donation receiver account, a demander account, and a performer account is generated and registered in an account information DB according to user information input from a user terminal; determining a donation, wherein the donation-related information input from the performer account is registered in a lifetime history information DB corresponding to the performer account; requesting the worker, wherein information related to a worker request proposal input from the demander account is registered in a worker request proposal DB; supporting the worker, wherein information related to the worker support proposal input from the performer account is registered in a worker support proposal DB; matching the worker, wherein worker request proposal information registered in the worker request proposal DB and worker support proposal information registered in the worker support proposal DB are analyzed and compared to match each other with a worker match whenever a worker request proposal is registered in the worker request proposal DB or a worker support proposal is registered in the worker support proposal DB; notifying a worker match, wherein worker match success information is registered in a worker match DB when the worker match is successful, worker match failure information is registered in the worker match DB when the worker match has failed, and then the worker match success information or the worker match failure information registered in the worker DB is transmitted to the corresponding specific performer account and specific demander account; and executing the donation, wherein the remittance to one or more of a corresponding financial institution of the specific performer account user, a corresponding financial institution of the donation receiver account user listed in the donation-related information, and a TDB donation account is managed by distributing a preset wage remitted from the specific demander account user according to the donation-related information input by the specific performer account user when worker execution information indicating that the specific performer account user has provided the worker to the specific demander account user is input from one or more of the specific demander account and the specific performer account to which the worker match success information is transmitted.

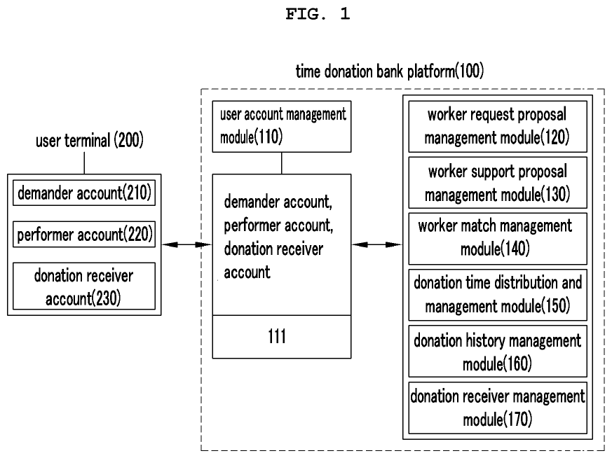

FIG. 1 is a block diagram showing a schematic configuration of a time donation bank platform according to the exemplary embodiment of the present invention.

As shown in FIG. 1, the time donation bank platform 100 is a system that includes a server and a database in hardware, and includes: a user account management module 110; a worker request proposal management module 120; a worker support proposal management module 130; a worker match management module 140; a donation time distribution and management module 150; a donation history management module 160; and a donation receiver management module 170. It is apparent that, when necessary, the system may be implemented without the donation history management module 160 and the donation receiver management module 170.

The user account management module 110 is a component for generating a user account for each participant who participates in the time donation bank platform 100, and registers and manages the user account in an account information DB 111, wherein any one of a user account 111 of a donation receiver account, a demander account, and a performer account is generated according to user information input from a user terminal 200, registered in the account information DB, and managed so that the changed user information in each user account is updated. Here, the user terminal 200 is a component capable of connecting to the time donation bank platform 100 through a wired or wireless communication network, and includes a personal computer such as a PC and a notebook computer which are able to connect to the Internet, or various electronic devices capable of performing wireless communication, or may be the personal computer such as a laptop or a PC, or a mobile device such as a smart phone or a smart pad.

Accordingly, a participant who desires to participate in the time donation bank platform 100 of the present invention may input own user information thereof after connecting to the time donation bank platform 100 by using own user terminal 200, and may generate and open any one account, by the user account management module 110, among a donation receiver account, a demander account, and a performer account. In this case, the demander account may be an individual, an organization, a public institution, or a for-profit institution, and since the demander account is opened to the participant who provides a job and desires to receive a worker suitable for the provided job, user information of a demander account user may be information such as company-related general information including address, business field, representative, revenue, and the like, and/or job information including a type of job to be provided, a hourly wage, and the like. Since a performer account is opened to a participant who desires to provide a worker for a suitable job, user information of a performer account user may be personal identification information including a phone number and an address, career information for providing a suitable worker, financial institution information for transactions, etc. When necessary, current status information of the performer account user may be further included. In a case where the performer account user is the elderly, the disabled, housewives, youth, or multicultural families, a priority may be given, so as to preferentially provide a paid volunteer job to the performer account user. Since the donation receiver account is opened to a participant who requests a donation from a performer, user information of the donation receiver account user may be various information suitable for attracting donations, the information including address, donation request reason, operation status, etc. When the user account is opened in this way, it is preferable to implement the time donation bank platform 100 to be accessed only with the opened user account.

The worker request proposal management module 120 is a component for registering and managing information, related to a worker request proposal input from a demander account, in the worker request proposal DB 121, and registers a specific worker request proposal in a worker request proposal DB 121 whenever the specific worker request proposal is input from the specific demander account user terminal 210. Among the registered worker request proposals, a relevant worker request proposal corresponding to the worker match may be registered and managed as follows whenever the worker match is successful or not by the worker match management module 140.

First, in a process of generating and registering worker match reservation information by the worker match management module 140, the worker request proposal management module 120 receives, from the worker match management module 140, an appropriate worker request proposal input from a performer account among the registered worker request proposals, and modifies and registers the appropriate worker request proposal as an optimal worker request proposal, and modifies and registers the optimal worker request proposal by attaching a worker match reservation tag thereto according to a signal transmitted to a performer account user terminal 220 and a demander account user terminal 210 after the worker match reservation information is generated by the worker match management module 140 and registered in a worker match DB 141.

Thereafter, the worker match success information is generated by the worker match management module 140 and registered in the worker match DB 141, and then the worker match reservation tag is modified and registered as the worker match success tag according to a signal transmitted to the performer account user terminal 220 and the demander account user terminal 210. Whereas, the worker match failure information is generated by the worker match management module 140, registered in the worker match DB 141, and then modified and registered by deleting the worker match reservation tag according to a signal transmitted to the performer account user terminal 220 and the demander account user terminal 210.

The worker support proposal management module 130 is a component for registering and managing information, which is related to the worker support proposal input from the performer account, in a worker support proposal DB 131, and registers a specific worker support proposal in the worker support proposal DB 131 whenever the specific worker support proposal is input from the specific performer account user terminal 220. Among the registered worker support proposals, a relevant worker support proposal corresponding to a worker match may be registered and managed as follows whenever the worker match is successful or not by the worker match management module 140.

First, in the process of generating and registering worker match reservation information by the worker match management module 140, the worker support proposal management module 130 receives an appropriate worker request proposal, from the worker match management module 140, input from a demander account among the registered worker support proposals, modifies and registers the appropriate worker request proposal as an optimal worker support proposal, and modifies and registers the optimal worker support proposal by attaching a worker match reservation tag thereto according to a signal transmitted to the demander account user terminal 210 and the performer account user terminal 220 after the worker match reservation information is generated by the worker match management module 140 and registered in the worker match DB 141.

After that, the worker match success information is generated by the worker match management module 140 and registered in the worker match DB 141, and then the worker match reservation tag is modified and registered as the worker match success tag according to a signal transmitted to the demander account user terminal 210 and the performer account user terminal 220. Whereas, the worker match failure information is generated by the worker match management module 140, registered in the worker match DB 141, and then modified and registered by deleting the worker match reservation tag according to a signal transmitted to the demander account user terminal 210 and the performer account user terminal 220.

The worker match management module 140 is a component for analyzing, comparing, and processing the worker request proposal information registered in the worker request proposal DB 121 and the worker support proposal information registered in the worker support proposal DB 131, matching each other with the worker match, and registering and managing the information, obtained upon progress or completion of the worker match, in the worker match DB. Information related to the executed worker match is respectively provided to the corresponding user terminals of the demander account and performer account, and additional measures may be performed as follows depending on whether the worker match is successful or not.

First, the worker match management module 140 may search the worker support proposal DB 131 for progress of a worker match for a specific worker request proposal registered in the worker request proposal DB 121 by the worker request proposal management module 120, transmit one or more appropriate worker support proposals to a specific demander account in which the specific worker request proposal is input when there is the worker support proposal that satisfies a worker match condition of the specific worker request proposal, determine the appropriate worker support proposal input from the specific demander account as an optimal worker support proposal, generate worker match reservation information in which the specific worker request proposal and the optimal worker support proposal are paired, register the worker match reservation information in the worker match DB 141, and then transmit the worker match reservation information to the specific demander account and the specific performer account to which the optimal worker support proposal is input.

In addition, the worker match management module 140 may search the worker request proposal DB 121 for progress of the worker match for a specific worker support proposal registered in the worker support proposal DB 131 by the worker support proposal management module 130, transmit one or more appropriate worker request proposals to a specific performer account when there is the worker request proposal that satisfies a worker match condition of the specific worker support proposal, determine the appropriate worker request proposal input from the specific performer account as an optimal worker request proposal, generate worker match reservation information in which the specific worker support proposal and the optimal worker request proposal are paired, register the worker match reservation information in the worker match DB 141, and then transmit the worker match reservation information to the specific demander account and the specific performer account to which the optimal worker support proposal is input.

In this way, the present invention may be implemented such that after the worker match reservation information is transmitted to the specific demander account and the specific performer account, when the specific condition is achieved, the worker match is successful, thereby generating the worker match success information. Whereas, when the specific condition is not achieved, the worker match has failed, thereby generating the worker match failure information. The specific conditions that determine whether or not the worker match is successful or not may be set in various ways. As an exemplary embodiment, within a predetermined period of time (e.g., 30 minutes to 1 hour when the time of a worker provision is on a same day, and 3 to 5 hours when the time of the worker provision is not on the same day) depending on the nature of a job, when a preset wage is pre-deposited from a demander account, it is determined that the worker match is successful, whereas when a preset wage is not pre-deposited from the demander account, it is determined that the worker match has failed, thereby respectively generating worker match success information or worker match failure information. After that, the worker match success information or worker match failure information is registered in the worker match DB 141, and then the worker match success information or worker match failure information is transmitted to the specific demander account and the specific performer account.

Meanwhile, when the worker match reservation tag is changed to a worker match failure tag by both the worker request proposal module 120 and the worker support proposal module 130 and respectively modified and registered in the worker request proposal DB 121 and the worker support proposal DB 131, the worker match management module 140 may re-perform the matching each other with the worker match for the specific worker request proposal or the specific worker support proposal, which constitute the worker match failure information.

When necessary, the worker match management module 140 may transmit a modification proposal recommendation message for a worker match condition of a specific worker request proposal to a specific demander account when a worker support proposal that satisfies the worker match condition of the specific worker request proposal input from the specific demander account does not exist in the worker support proposal DB 131, or may transmit a modification proposal recommendation message for a worker match condition of a specific worker support proposal to a specific performer account when a worker request proposal that satisfies the worker match condition of the specific worker support proposal input from the specific performer account does not exist in the worker request proposal DB 121.

A donation time distribution and management module 150 is a component in which when worker execution information indicating that a corresponding performer account user has actually completed the provision of a worker to a demander account user is input from one or more of a specific performer account and a specific demander account according to the worker match success information registered by the worker match management module 140, a preset wage remitted from the specific demander account user is donated at a predetermined rate and transferred to the performer account user, and then new history information of the demander account user and the performer account user, that is, new job provision history information and new donation history information of the demander account user and the performer account user are respectively generated, transmitted, and managed.

Therefore, by distributing the preset wage remitted from the specific demander account user according to the donation-related information determined by the specific performer account user, the donation time distribution and management module 150 may manage to remit money to one or more of the corresponding financial institution of the specific performer account user, the corresponding financial institution of the donation receiver account user, and the TDB donation account, which are listed in the donation-related information.

Here, the preset wage may be remitted from the demander account user to a virtual account of the time donation bank platform 100 or a cooperative financial institution 300, and in particular, in a case of remittance to the cooperative financial institution 300, the donation time distribution and management module 150 may perform remittance management by transmitting financial transaction information for remittance to the cooperative financial institutions, the financial transaction information including: amounts distributed to the cooperative financial institutions 300 at a predetermined rate according to the donation-related information; and one or more of the following to which the distributed amount is to be deposited: corresponding financial institution information of the performer account user, corresponding financial institution information of the donation receiver account user, and the TDB donation account information. When necessary, the donation time distribution and management module 150 may be implemented to deduct a predetermined rate of the preset wage remitted from the demander account user as a fee for using the time donating bank platform, and then distribute the preset wage according to the donation-related information. Here, it is apparent that the fee for using the time donation bank platform may not be the preset wage, but may be determined by a preset rate of the amount distributed to the performer according to the donation-related information.

The donation history management module 160 is a component for receiving donation-related information from a performer account user, registering the donation-related information in a lifetime history information DB corresponding to the performer account, receiving new donation history information to update and manage performer lifetime history information including the donation-related information and new donation history information in the lifetime history information DB 161, receiving new job provision history information including the job hours generated and the wage paid, by the demander account user, and register the new job provision history information in the lifetime history information DB corresponding to the demander account, and update and manage demander lifetime history information, including the job provision history information, in the lifetime history information DB 161.

Accordingly, when the performer lifetime history information and the demander lifetime history information which are registered in the lifetime history information DB 161 are updated, the donation history management module 160 respectively transmits the updated performer lifetime history information and demander lifetime history information to the corresponding performer account and demander account.

In addition, when confirmation document issuance request information on one's time donation activity is input from one or more of the performer account and the demander account, the donation history management module 160 registers the confirmation document issuance request information in the lifetime history information DB 161, searches for performer lifetime history information and demander lifetime history information of one or more of the specific performer account and demander account corresponding to the confirmation document issuance request information, and transmits the confirmation document issuance request information to the searched specific donation receiver account. When the confirmation document about volunteer donation activity is input from the donation receiver account, the donation history management module 160 registers the confirmation document issuance request information in the lifetime history information DB 161, and then transmits the information to the specific performer account and demander account to which the confirmation document issuance request information is input.

Here, the donation-related information is determined by the performer account user, input from a performer account user terminal 220, and registered corresponding to the performer account, and includes donation plan information including donation rate information and donation receiver information, which are information on wages obtained when the provision of a worker is completed. The donation rate information of the donation plan information is information where a donation rate of a wage obtained when a performer completes the provision of a worker is determined in a range from the minimum of 5% to the maximum of 100%, and the donation rate information may be changed at a request of the performer according to the economic situation thereof. The donation receiver information of the donation plan information includes a name of donation receiver who has been selected by the performer to donate his or her donation by searching for a donation receiver account user (i.e., legal donation beneficiaries such as orphanages, nursing homes, and other social welfare providers), opened on the time donation bank platform 100. The donation receiver information may also be changed by the performer at any time. Meanwhile, the performer may decide to make a donation by depositing donation in a TDB donation account without selecting the donation receiver, but selecting the donation receiver later. When necessary, the donation plan information may further include the following information on financial institutions to which a distributed amount is to be transferred: information of a performer account user, information of a donation receiver account user, and information of TDB account.

Donation history information may include time donation history information in which the support time of a performer account user up to the present time is converted into donation time for other people and donation time for oneself according to information on donation amount and donation rate for each donation receiver. Here, the support time of the performer account user is given 2 dona (i.e., a nickname for donation, which is a time-measured monetary unit unique to the time donation bank platform) per support hour every time one piece of worker execution completion information is registered in the worker match DB 151. The time donation history information may be generated by distributing the donation time for oneself and donation time for other people as follows according to the donation rate determined by the performer account user. That is, as described above, the donation rate information may be determined such that the minimum donation rate is 5% of a wage and the maximum donation rate is 100% of the wage. The time donation history information is generated by a setting in which as 2 dona is given per hour, when 3 hours of support time in a piece of registered worker execution completion information is supported by a performer to complete the worker execution, a total of 6 dona is given. Only when the donation rate information has the maximum donation rate of 100%, all 6 dona may be given to the item of donation time for other people. When the donation rate information is less than 5% to 100%, 3 dona is given to the item of donation time for other people and 3 dona is given to the item of donation time for oneself.

As a result, through the time donation history information accumulated for a performer account user, a degree of donations and volunteer work of the performers is not converted to the price of donations, but to the fair amount of time given to the performers on the time donation bank platform 100, whereby how much of each individual's most valuable asset, that is his or her time, has been donated to others may be evaluated and published. In this way, changing the donation measurement from money to time and valuing all people fairly and equally regardless of rich or poor may become an important standard to respect human values.

In addition, as for a demander account user, through demander lifetime history information that includes the accumulated and managed job provision history information including the job hours generated and the wage paid, by the demander account user, the degree of social contribution of the demander account user may be indirectly evaluated and published.

The donation receiver management module 170 is a component for registering, in a donation receiver DB 171, basic information about the donation receiver that requests a donation input from a donation receiver account and the donation request-related information including financial institution information of the donation receiver, and updates and manages donation receiver information including the donation request-related information. It is apparent that, when necessary, the donation receiver management module 170 may not be implemented separately, but included in the user account management module 110.

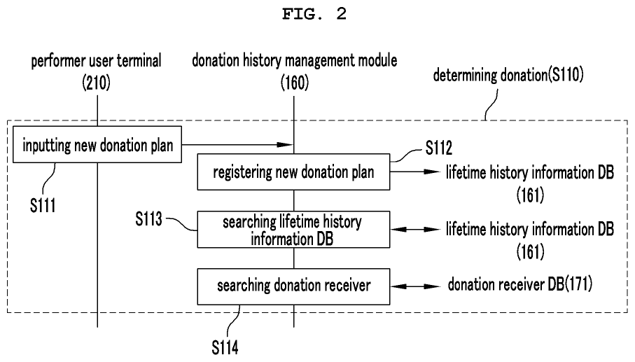

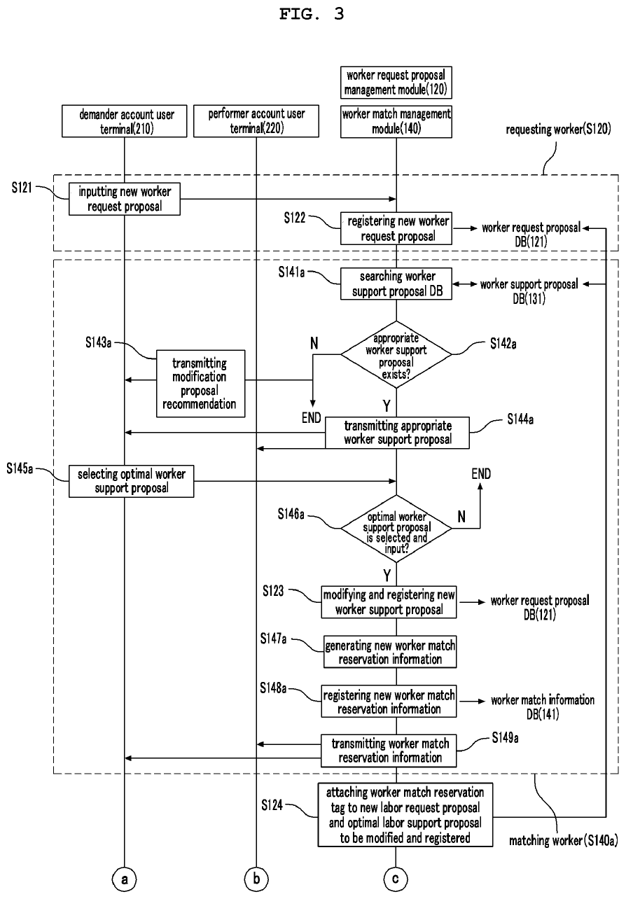

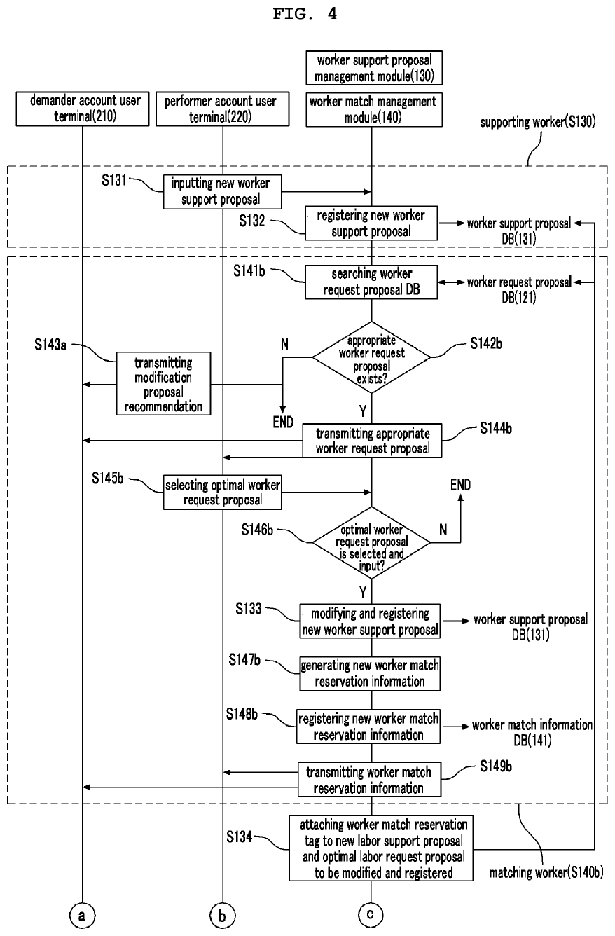

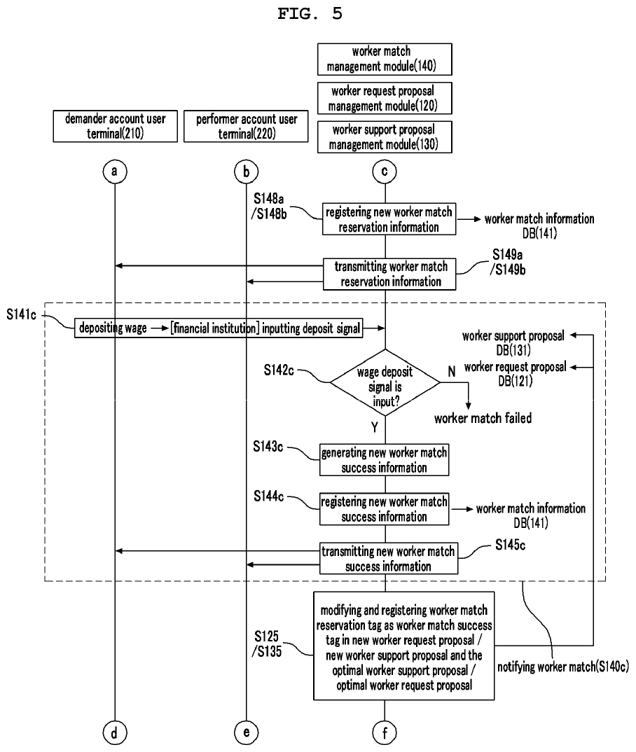

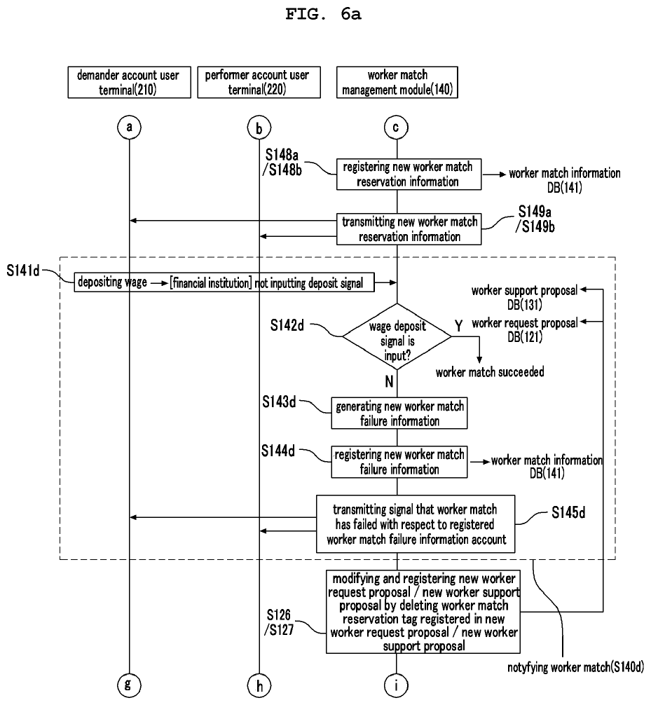

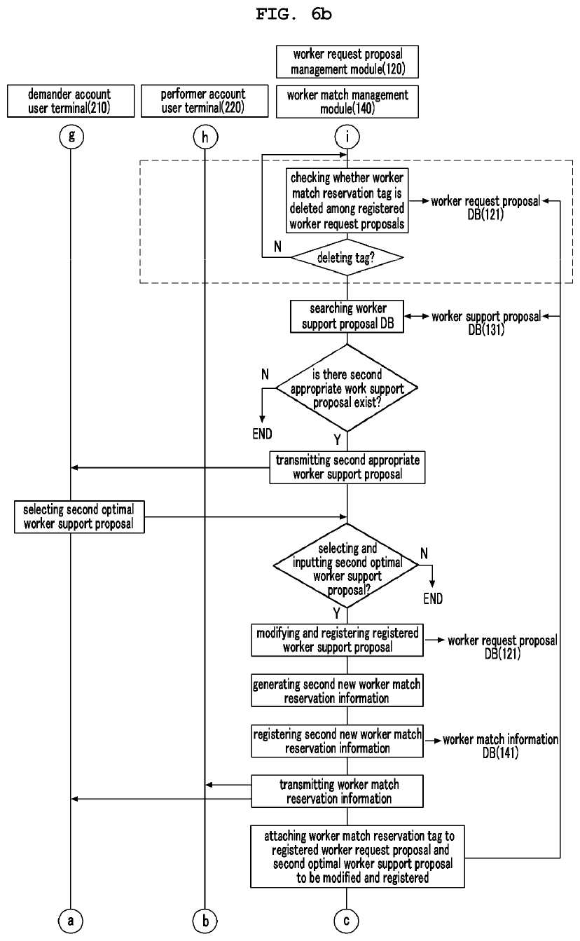

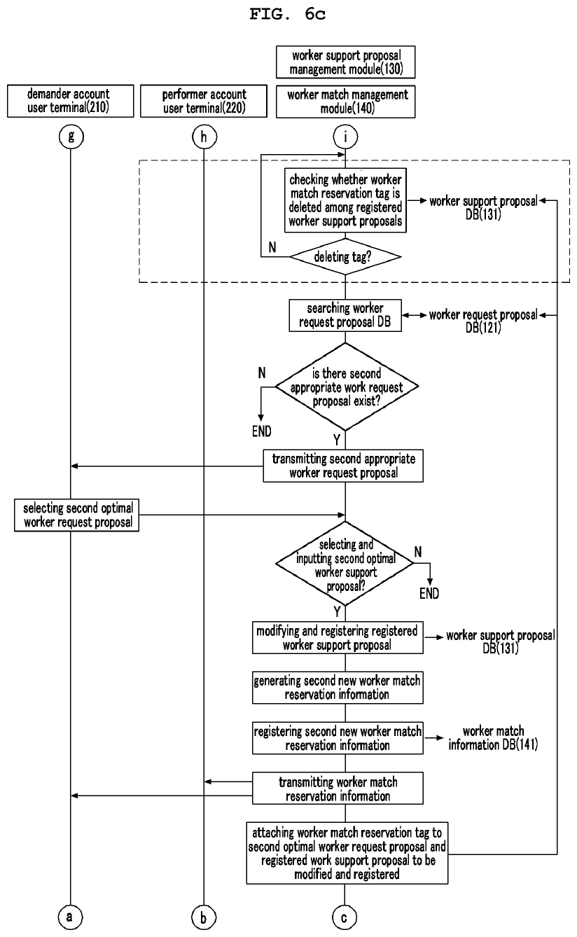

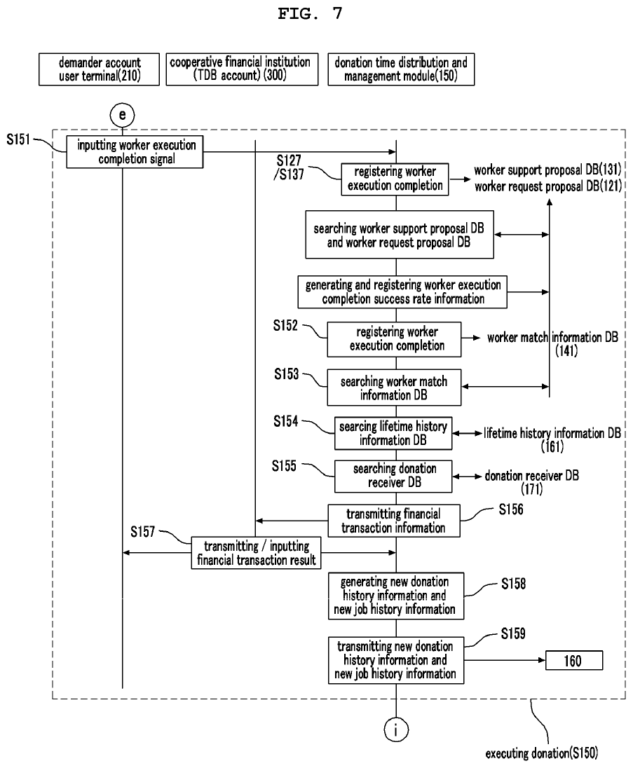

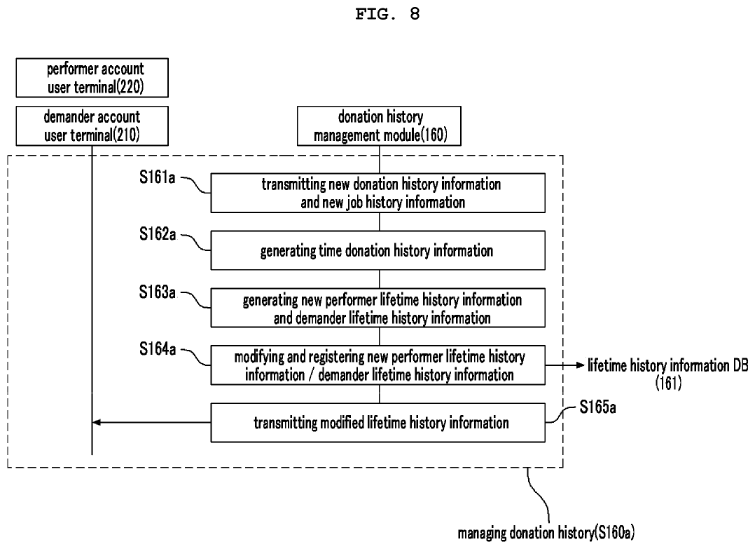

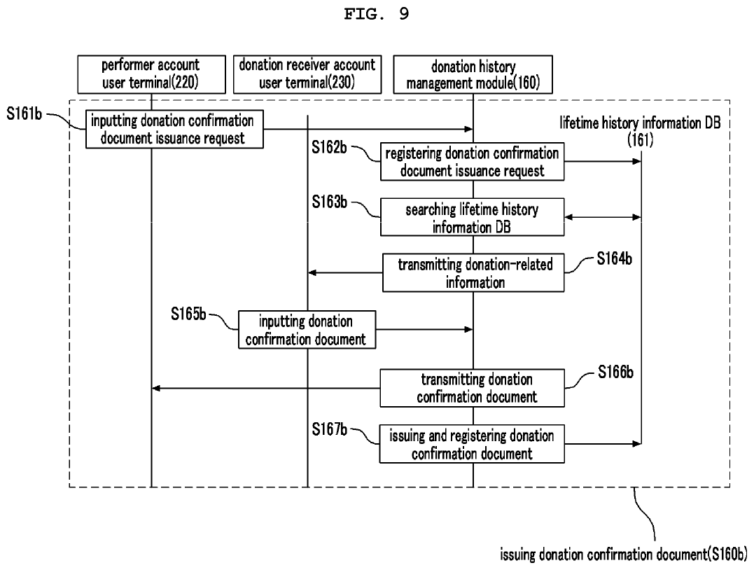

FIG. 2 is a flowchart showing a process that is performed when donation-related information is determined and registered by a performer account user in the time donation bank platform shown in FIG. 1. FIG. 3 is a flowchart showing a process in which a match of a worker is performed after new worker request proposal information is registered in the time donation bank platform shown in FIG. 1. FIG. 4 is a flowchart showing a process in which the matching of the worker is performed after new worker support proposal information is registered in the time donation bank platform shown in FIG. 1. FIG. 5 is a flowchart showing a process in which notifying a worker match is performed when the worker match is successful according to new worker match reservation information registered according to FIGS. 3 and 4. FIG. 6a is a flowchart showing a process in which the notifying of the worker match is performed when the worker match has failed according to the new worker match reservation information registered according to FIGS. 3 and 4. FIG. 6b is a flowchart showing a process in which the matching of the worker is performed after worker match failure information is registered according to FIG. 6a and treated as new worker request proposal information in the same manner as in FIG. 4, so as to be registered as second new worker match reservation information. FIG. 6c is a flowchart showing a process in which the matching of the worker is performed after the worker match failure information is registered according to FIG. 6a and treated as new worker support proposal information in the same manner as in FIG. 4, so as to be registered as second new worker match reservation information. FIG. 7 is a flowchart showing a process in which executing a donation is performed after executing the worker is completed according to worker match success information transmitted from FIG. 5. FIG. 8 is a flowchart showing a process in which managing donation history is performed after the executing of the donation is completed in FIG. 7. FIG. 9 is a flowchart showing a process of issuing a donation confirmation document requested on the basis of the donation-related information registered corresponding to a performer account when a donation is executed.

With reference to FIGS. 2 to 9, the exemplary embodiment of the time donation method performed on the time donation bank platform 100 of the present invention will be described in detail.

The time donation method of the present invention may be implemented by including: generating an account, determining a donation, requesting a worker, supporting the worker, matching the worker, notifying a worker match, and executing the donation, and when necessary, may further include: managing donation history; and issuing a donation confirmation document.

First, generating an account may be performed by a user account management module, wherein any one of a donation receiver account, a demander account, and a performer account is generated according to user information input from a user terminal, and registered in an account information DB. In the generating of the account, the demander account may be opened to a participant who desires to provide a job and to receive a worker suitable for the provided job, the performer account may be opened to a participant who desires to provide the worker for the suitable job, and the donation receiver account may be opened to a participant who requests donations from performers.

After the generating of the account is performed, step S110 of determining a donation in which donation-related information input from the performer account is registered in the lifetime history information DB corresponding to the performer account is performed by the donation history management module 160.

As shown in FIG. 2, step S110 of determining a donation includes: step S111 of inputting donation-related information, including a new donation plan, from a performer account user terminal 220; and step S112 of registering the input donation-related information in the lifetime history information DB. Here, as described above, the donation-related information includes donation plan information including donation rate information and donation receiver information, wherein it may be implemented such that when a performer does not determine who will be a donation receiver, by default, a donation is accumulated in a TDB account, which is a donation account of the time donation bank platform 100, according to the donation rate information determined by the performer, and afterwards, when the performer determines a donation receiver, the donation is executed. Accordingly, when necessary, one or more steps of step S113 and step S114 may be performed before and/or after step S112 of registering a donation plan, the one or more steps including: step S113 of checking ability to donate, such as searching for the performer lifetime history information registered in the lifetime history information DB and checking a donation possible balance accumulated in a TDB account corresponding to the relevant performer account in order to check whether a donation plan entered by the performer is feasible; and step S114 of searching, by the performer, the donation receiver DB to input donation-related information.

After step S110 of determining a donation is performed, one or more steps may be performed simultaneously or sequentially out of order, the one or more steps including: step S120 of requesting the worker, wherein information related to a worker request proposal input from a demander account is registered in the worker request proposal DB by the worker request proposal management module 120; and step S130 of supporting the worker, wherein information related to the worker support proposal input from a performer account is registered in the worker support proposal DB by the worker support proposal management module 130. When necessary, step S120 of requesting the worker or step S130 of supporting the worker may be performed simultaneously with step S110 of determining a donation, or may be performed first, making no difference.

After that, steps S140a and S140b of matching the worker are performed. As shown in FIGS. 3 and 4, whenever a worker request proposal is registered in the worker request proposal DB or a worker support proposal is registered in the worker support proposal DB, steps S140a and S140b of matching the worker may be performed by analyzing, comparing, and processing the worker request proposal information registered in the worker request proposal DB and the worker support proposal information registered in the worker support proposal DB, by the worker match management module 140, so as to be matched each other with the worker match.

First, a process in which step S120 of requesting a worker is performed and then step S140a of matching the worker is performed will be described with reference to FIG. 3.

When step S120 of requesting a worker is performed, the following steps proceed, the step 120 including: step S121 of inputting a new worker request proposal from a specific demander account user terminal 210; and step S122 of registering the input new worker request proposal in the worker request proposal DB.

In step S141, the worker support proposal DB is retrieved, and step S142a of comparing and analyzing whether or not there is a specific worker request proposal, i.e., a worker request proposal that satisfies a worker match condition of the new worker request proposal, input from a specific demander account is performed.

In step S143a, when there is no worker support proposal that satisfies the worker match condition, the process is terminated or a modification proposal recommendation message is transmitted. Step S144a of transmitting one or more appropriate worker support proposals to a specific demander account when there is an appropriate worker support proposal may be performed.

In step S145a, an appropriate worker support proposal is selected and input from the specific demander account. In step S146a, the appropriate worker support proposal is determined as an optimal worker support proposal. In step S147a, worker match reservation information in which a specific worker request proposal and an optimal worker support proposal are paired is generated. In step S148a, the worker match reservation information is registered in the worker match DB, and then step S149a of transmitting the worker match reservation information to the specific demander account and the specific performer account, to which the optimal worker support proposal is input, is performed. Here, when necessary, in step S123, the new worker request proposal corresponding to the optimal worker support proposal transmitted to the performer account user terminal 210 after step S146a may be modified and registered in the worker request proposal DB in the same manner as the condition of the optimal worker support proposal by the worker request proposal management module 120.

In addition, a process in which step S140b of matching the worker is performed after step S130 of supporting a worker is performed will be described with reference to FIG. 4.

When step S130 of supporting the worker is performed, the following steps proceed, the step S130 including: step S131b of inputting a new worker support proposal, which is a specific worker support proposal, from a specific performer account user terminal 220; and step S132 of registering the input new worker support proposal in the worker support proposal DB.

Step S141 of searching the worker request proposal DB and step S142b of comparing and analyzing whether or not there is a specific worker support proposal input from a specific demander account, i.e., a worker request proposal that satisfies a worker match condition of the new worker support proposal are performed.

In step S143b, when there is no worker request proposal that satisfies the worker match condition, the process is terminated or a modification proposal recommendation message is transmitted. When there is an appropriate worker request proposal, step S144b of transmitting one or more appropriate worker request proposals to the specific performer account may be performed.

In step S145b, an appropriate worker request proposal is selected and input from the specific performer account. In step S146b, the appropriate worker request proposal is determined as an optimal worker request proposal. In step S147b, worker match reservation information in which the specific worker support proposal and the optimal worker request proposal are paired is generated. In step S148b, the worker match reservation information is registered in the worker match DB, and then step S149b of transmitting the worker match reservation information to the specific performer account and the specific demander account, to which the optimal worker request proposal is input, is performed. Here, when necessary, in step S133, the new worker support proposal corresponding to the optimal worker request proposal transmitted to the demander account user terminal 210 after step S146b is performed may be modified and registered in the worker support proposal DB in the same manner as the condition of the optimal worker request proposal by the worker support proposal management module 130.

Thereafter, as shown in FIGS. 3 and 4, steps of S124 and S134 may be performed simultaneously or sequentially, wherein, by attaching a worker match reservation tag to each of the specific worker request proposal and the optimal worker support proposal or the specific worker support proposal and the optimal worker request proposal, which constitute the worker match reservation information, the worker match reservation information transmitted to the specific performer account and the specific demander account may be modified and registered in the worker request proposal DB and the worker support proposal DB.

In this way, after the matching of the worker is performed, steps S140c and S140d of notifying a worker match may be performed, wherein the worker match success information is registered in the worker match DB when the worker match is successful, the worker match failure information is registered in the worker match DB when the worker match has failed, and then the worker match success information or worker match failure information, registered in the worker match DB, is transmitted to the corresponding specific performer account and specific demander account.

First, with reference to FIG. 5, in a case where the worker match is successful, referring to step S140c of notifying a worker match as the exemplary embodiment, In step S141c, when a wage deposit signal in which a wage included in a specific worker request proposal is deposited within a preset time is input from the specific demander account to which the worker match success information which is a preset condition as a worker match success condition is transmitted is input, step S142c of determining whether or not the wage deposit signal is input is performed, step S143c of determining that the worker match is successful and generating the worker match success information is performed, step S144c of registering the worker match success information in the worker match DB is performed, and then step S145c of transmitting the worker match success information to a specific demander account and a specific performer account may be performed. Thereafter, steps S125 and S135 may be performed, wherein a worker match reservation tag attached to each of proposals including: a specific worker request proposal and an optimal worker support proposal; or a specific worker support proposal and an optimal worker request proposal, which constitute the worker match success information, is changed to a worker match success tag, and modified and registered in the worker request proposal DB and worker support proposal DB.

Meanwhile, as shown in FIG. 6a, in a case where the worker match has failed, in step S140d of notifying a worker match is performed as an exemplary embodiment. In step S141d, when a wage deposit signal in which a wage included in a specific worker request proposal is deposited within a preset time is not input from a specific demander account to which worker match reservation information, which is a preset condition as a worker match failure condition, is transmitted, step S142d of determining whether or not the wage deposit signal is input is performed, step S143d of determining that the worker match has failed and generating worker match failure information is performed, step S144d of registering the worker match failure information in the worker match DB is performed, and then step S145d of transmitting the worker match failure information to the specific demander account and the specific performer account may be performed. Thereafter, steps S126 and S136 may be performed, wherein a worker match reservation tag attached to each of proposals including: a specific worker request proposal and an optimal worker support proposal; or a specific worker support proposal and an optimal worker request proposal, which constitute the worker match failure information, is changed to a worker match failure tag, and modified and registered in the worker request proposal DB and the worker support proposal DB.

In this way, when the worker match reservation tag is changed to the worker match failure tag, and modified and registered in the worker request proposal DB and the worker support proposal DB, as shown in FIGS. 6b and 6c, the matching of the worker may be re-performed for proposals including: the specific worker request proposal; or the specific worker support proposal, which constitute the worker match failure information.

Except for the fact that the worker match reservation tag is changed to the worker match failure tag, i.e., the tag is deleted, and modified and registered in the worker request proposal DB and the worker support proposal DB, the matching of the worker shown in FIGS. 6b and 6c is the same as in the flowcharts respectively shown in FIGS. 3 and 4, so a detailed description will be omitted. As shown, the changing of the worker match reservation tag to the worker match failure tag may be implemented simply by deleting the worker match reservation tag.

In step S140c of notifying a worker match, in a case where the worker match success information is transmitted as shown in FIG. 5, when worker execution information indicating that a specific performer account user has provided the worker to a specific demander account user is input from one or more of the specific demander account and the specific performer account to which the worker match success information is transmitted, step S150 of distributing a preset wage may be performed, wherein the preset wage is remitted from a specific demander account user according to donation-related information input by a specific performer account user and managing the remittance to one or more of the corresponding financial institution of the specific performer account user, the corresponding financial institution of the demander account user listed in the donation-related information, and the TDB donation account.

The step S150 of executing a donation performed by the donation time distribution and management module 150 will be described in more detail with reference to FIG. 7. As shown, in step S151, when the worker execution completion information indicating that the performer has provided a worker to the demander is performed is actually input, step S152 of registering worker execution completion is performed by attaching the worker execution completion tag to the corresponding worker match success information registered in the worker match information DB. In step S153, a worker match information DB is retrieved in order to verify the preset wage included in the corresponding worker match success information in the worker match information DB. In step S154, the lifetime history information DB is searched in order to confirm donation-related information on the wage to be received by the performer who has completed the worker execution, the donation-related information including: financial transaction information of the performer; the donation rate set by the performer; donation receiver information set by the performer; and the like. Step S155 of searching for donation receiver financial transaction information in the donation receiver DB when the donation receiver information is composed of only the name of the donation receiver may be further performed. Step S156 of transmitting financial transaction information is performed, wherein a preset wage is distributed as incentive to be remitted to a performer and a donation to be remitted to a donation receiver according to the searched donation rate, and any one of the incentive, the donation, financial institution account information of the performer account user, financial institution account information of the donation receiver account user, and TDB donation account information is included in the financial transaction information. In step S157, when a financial transaction result where an account transfer is performed according to the transmitted financial transaction information is input, new donation history information and new job history information are generated and transmitted to the donation history management module in step S159.

Here, in step S151, when worker execution completion information is input, steps S127 and S137 may be further performed, wherein the worker match success tag each attached to the worker support proposal and worker request proposal, which are respectively registered in the worker support proposal DB and the worker request proposal DB, is changed to a worker match completion tag to be modified and registered. When necessary, it is also possible to search the worker support proposal DB and the worker request proposal DB, calculate a success rate of the worker match success and worker execution completion of the demander account user and performer account user, and then register the success rate in the worker support proposal DB and the worker request proposal DB. When such a success rate is registered, the success rate may be used to help the performer account user and the demander account user to search each DB in advance to find a candidate counterpart having a high success rate.

In this way, after step S150 of executing a donation is performed, step S160a of managing donation history and step S160b of issuing a donation confirmation document are further performed by the donation history management module 160 as follows.

As shown in FIG. 8, in step S160a of managing donation history, first, step S161a of receiving transmitted new donation history information and new job provision history information, which are generated in step S150 of executing a donation, is performed. Thereafter, step S162a of generating time donation history information in which the support time of the specific performer account user is converted into donation time of other people and donation time for oneself according to the new donation history information is performed. The time donation history information is generated in a method of distributing, accumulating, and registering 2 dona per support hour, given to a performer account user according to the new donation history information, into the item of donation time for other people and the item of donation time for oneself on the basis of the donation rate information included in the new donation history information.

When the time donation history information is generated, step S163a of generating new demander lifetime history information of a specific demander account user is performed according to the new performer lifetime history information and/or new job provision history information, which include the donation amount and time donation history information accumulated up to the present time for each donation receiver, the new demander lifetime history information including local job generation time and local job support fund (i.e., total paid wage), which are accumulated up to the present time.

Step S164a of modifying and registering the generated new performer lifetime history information and new demander lifetime history information in the lifetime history information DB is performed, and step S165a of respectively transmitting the modified lifetime history information to the performer account user terminal 220 and the demander account user terminal 210 may be performed.

As shown in FIG. 9, in step S160b of issuing a donation confirmation document, first, step S161b of inputting confirmation document issuance request information for time donation activities from a performer account user terminal is performed. After step S162a of registering the input confirmation document issuance request information (i.e., donation amount confirmation document and/or service hour confirmation document including time donation history information, etc.) in the lifetime history information DB is performed, step S163b of searching the lifetime history information DB in order to confirm donation-related information such as a donation receiver and donation amount registered in the performer lifetime history information of the corresponding performer account user is performed. In step S164b, the donation related information is transmitted to the searched donation receiver account user terminal 230, and issuance of a donation confirmation document is requested. In step S165b, when the donation confirmation document issued from the donation receiver account user terminal is input, the input donation confirmation document is transmitted to the performer account user terminal 220 in step S166b, and in step S167b, the fact that the donation confirmation document was issued is registered in the lifetime history information DB. When necessary, the issued donation confirmation document may also be registered corresponding to the performer lifetime history information.

As an exemplary embodiment, the donation confirmation document issued in step S160b of issuing a donation confirmation document may be the donation amount confirmation document and the service hour confirmation document. Since the donation amount confirmation document is issuable only from a donation receiver who may legally issue the donation amount confirmation document, the donation amount confirmation document may be issued as shown in FIG. 9, but since the service hour confirmation document is issuable on the time donation bank platform of the present invention, when an issuance request for a donation confirmation document, i.e., a service hour confirmation document, is input from the performer account user terminal, the donation history management module 160 registers the issuance request for a donation confirmation document in the lifetime history information DB, searches the lifetime history information DB, generates the service hour confirmation document, transmits the service hour confirmation document to the performer account user terminal, and then may register the service hour confirmation document in the lifetime history information DB. Therefore, there is an effect that through the time donation history information accumulated up to the time of issuance of the service hour confirmation document, in particular, through the total amount of dona accumulated in the item of donation time for other people, all performer account users may objectively prove to themselves or a third party, through the service hour confirmation document, that how meaningfully one's time is used for others out of the time that everyone has equitably.

Meanwhile, when an issuance request for a confirmation document is input from the specific demander account user terminal, the donation history management module 160 registers the issuance request for the confirmation document in the lifetime history information DB, searches the lifetime history information DB, checks the accumulated local job generation time and the accumulated local support amount which are registered in the lifetime history information DB of the corresponding demander account user, generates the job contribution confirmation document, transmits the job contribution confirmation document to the performer account user terminal, and then may register the job contribution confirmation document in the lifetime history information DB.

In this way, through the donation confirmation document issued by the time donation bank platform of the present invention or the donation receiver account user, the performer account user may use the donation confirmation document for year-end tax adjustment, submission to school, and the like. In addition, the demander account user may use the donation confirmation document for corporate promotion such as CSR (Corporate Social Responsibility), cause marketing, and delivery of good will to consumers.

Next, an application for time donation activity according to the present invention is installed on a user terminal connected to the time donation bank platform of the above configuration in order for time donation activity information of an account user generated in the time donation bank platform to be transmittable in both directions, whereby the application may be implemented to be executed so that the account user is able to recognize input and output of the time donation activity information, the input and output being performed through the time donation bank platform. Here, the user terminal to which the application for time donation activity of the present invention is installed may be any one of a PC, a notebook computer, a smart phone, and a tablet.

Through this configuration, the time donation bank platform may manage the service and donation history of performers and demanders for a lifetime. The present time donation bank platform is the only platform that accumulates and manages service and donation history for a lifetime and provides the information in real time upon request.

As described above, the present invention has been illustrated and described with reference to preferred exemplary embodiments, but is not limited to the above-described exemplary embodiments, and various changes and modifications can be embodied by those skilled in the art to which the present invention belongs without departing from the spirit of the present invention.

1: A time donation bank platform comprising:
a user account management module configured to generate a user account comprising a donation receiver account, a demander account, and a performer account according to user information input from a user terminal, and register and manage the user account in an account information DB;
a worker request proposal management module configured to register and manage information related to a worker request proposal input from the demander account in a worker request proposal DB;
a worker support proposal management module configured to register and manage information related to a worker support proposal input from the performer account in a worker support proposal DB;
a worker match management module configured to analyze, compare, and process worker request proposal information registered in the worker request proposal DB and worker support proposal information registered in the worker support proposal DB so as to match each other with a worker match, respectively provide information related to the worker match to a corresponding demander account user terminal and performer account user terminal, take additional measures depending on whether the worker match is successful or not, and register and manage information obtained upon progress or completion of the worker match in a worker match DB; and
a donation time distribution and management module configured to distribute a preset wage remitted from a specific demander account user according to donation-related information determined by a specific performer account user when worker execution information is input from one or more of a specific performer account and a specific demander account, the worker execution information indicating that the specific performer account user in response after the worker match performed by the worker match management module is successful has provided a worker to the specific demander account user, manage remittance to one or more of a corresponding financial institution of the specific performer account user, a corresponding financial institution of a donation receiver account user listed in the donation-related information, and a time donation bank (TDB) donation account, perform remittance management by transmitting financial transaction information for the remittance when the preset wage is remitted from a demander account user to cooperative financial institutions, the financial transaction information comprising amounts respectively distributed to the cooperative financial institutions at a predetermined rate according to the donation-related information and one or more pieces of the following information of financial institutions to which the distributed amounts is to be deposited: information of the corresponding financial institution of the performer account user, information of the corresponding financial institution of the donation receiver account user, and information of the TDB donation account, and generate, transmit, and manage worker execution completion information, new donation history information, and new job provision hi story information.

2: The time donation bank platform of claim 1, further comprising:
a donation history management module configured to receive the donation-related information from the performer account user, register the donation-related information in a lifetime history information DB corresponding to the performer account, receive the new donation history information, update and manage performer lifetime history information comprising the donation-related information and the new donation history information in the lifetime history information DB, receive the new job provision history information comprising job hours generated and the wage paid, by the demander account user, register the new job provision history information in the lifetime history information DB corresponding to the demander account, and update and manage demander lifetime history information comprising the job provision history information in the lifetime history information DB.

3: The time donation bank platform of claim 1, further comprising:
a donation receiver management module configured to register, in a donation receiver DB, basic information on a donation receiver that requests a donation input from the donation receiver account and donation request-related information comprising financial institution information of the donation receiver, and update and manage donation receiver information comprising the donation request-related information.

4: The time donation bank platform of claim 1, wherein the donation-related information comprises:
donation rate information for the wage obtained when worker provision is completed;
donation plan information comprising the donation receiver information; and
one or more pieces of the following information of the financial institutions to which the amounts distributed according to the donation plan information is transferred: information of the performer account user, information of financial institution of the donation receiver account user, and information of the TDB donation account,
the donation history information comprises donation amount for each donation receiver and time donation history information in which support time of the performer account user up to the present time is converted into donation time for other people and donation time for oneself according to donation rate information,
the support time of the performer account user is provided with 2 dona (i.e., donations) per support hour each time when a piece of the worker execution completion information is registered in the worker match DB,
the donation rate information is able to determine rates such that a minimum donation rate is 5% of a wage and a maximum donation rate is 100% of the wage, and
the time donation history information is registered and managed cumulatively so that 2 dona is given per support hour for a piece of the registered worker execution completion information, all 2 dona are given to an item of the donation time for other people when the donation rate information has the maximum donation rate of 100%, and 1 dona is given to the item of the donation time for other people and 1 dona is given to an item of the donation time for oneself when the maximum donation rate is in a range from greater than or equal to 5% to less than 100%.

5: The time donation bank platform of claim 4, wherein, when confirmation document issuance request information for one's time donation activity is input from any one or more of the performer account and the demander account, a donation history management module registers the confirmation document issuance request information in a lifetime history information DB, searches performer lifetime history information and demander lifetime history information of one or more of the specific performer account and the demander account corresponding to the confirmation document issuance request information, and transmits the confirmation document issuance request information to the searched specific donation receiver account, and
when a confirmation document of service donation activity is input from the donation receiver account, the donation history management module registers the confirmation document in the lifetime history information DB, and transmits the confirmation document to the specific performer account and the demander account, to which the confirmation document issuance request information is input.

6: The time donation bank platform of claim 1, wherein, when a specific worker request proposal input from the specific demander account is registered in the worker request proposal DB by the worker request proposal management module, the worker match management module searches the worker support proposal DB for a progress of the worker match, and when there is the worker support proposal that satisfies a worker match condition of the specific worker request proposal, the worker match management module transmits one or more appropriate worker support proposals to the specific demander account, determines the appropriate worker support proposal input from the specific demander account as an optimal worker support proposal, generates worker match reservation information in which the specific worker request proposal and the optimal worker support proposal are paired, registers the worker match reservation information in the worker match DB, and then transmits the worker match reservation information to the specific demander account and the specific performer account to which the optimal worker support proposal is input, or
when a specific worker support proposal input from the specific performer account is registered in the worker support proposal DB by the worker support proposal management module, the worker match management module searches the worker request proposal DB for the progress of the worker match, and when there is the worker request proposal that satisfies the worker match condition of the specific worker support proposal, the worker match management module transmits one or more appropriate worker request proposals to the specific performer account, determines the appropriate worker request proposal input from the specific performer account as an optimal worker request proposal, generates the worker match reservation information in which the specific worker support proposal and the optimal worker request proposal are paired, registers the worker match reservation information in the worker match DB, and then transmits the worker match reservation information to the specific performer account and the specific demanding party account to which the optimal worker request proposal is input, and when the worker match reservation information is transmitted to the specific demander account and the specific performer account by the worker match management module, the worker match management module respectively attaches worker match reservation tags to the specific worker request proposal and the optimal worker support proposal or the specific worker support proposal and the optimal worker request proposal, which constitute the worker match reservation information, by the worker request proposal management module and the worker support proposal management module to modify and register the proposals in the worker request proposal DB and the worker support proposal DB.

7: The time donation bank platform of claim 1, wherein, when a wage deposit signal in which the wage included in a specific worker request proposal is deposited within a preset time is input from the specific demander account to which worker match reservation information is transmitted, the worker match management module generates worker match success information, registers the worker match success information in the worker match DB, and then transmits the worker match success information to the specific demander account and the specific performer account, and
the worker match reservation tags respectively attached to the specific worker request proposal and the optimal worker support proposal or a specific worker support proposal and an optimal worker request proposal, which constitute the worker match success information, are changed to worker match success tags, by the worker request proposal management module and the worker support proposal management module, and modified and registered in the worker request proposal DB and the worker support proposal DB.

8: The time donation bank platform of claim 1, wherein, when a wage deposit signal in which the wage included in a specific worker request proposal is deposited within a preset time is not input from the specific demander account to which worker match reservation information is transmitted, the worker match management module generates worker match failure information, registers the worker match failure information in the worker match DB, and then transmits the worker match failure information to the specific demander account and the specific performer account, and
the worker match reservation tags respectively attached to the specific worker request proposal and an optimal worker support proposal or a specific worker support proposal and an optimal worker request proposal, which constitute the worker match failure information, are changed to worker match failure tags, by the worker request proposal management module and the worker support proposal management module, and modified and registered in the worker request proposal DB and the worker support proposal DB.

9: The time donation bank platform of claim 8, wherein, when the worker match reservation tag is changed to the worker match failure tag and registered in the worker request proposal DB and the worker support proposal DB, the matching each other with the worker match is re-performed, by the worker match management module for the specific worker request proposal or the specific worker support proposal, which constitute the worker match failure information.

10: The time donation bank platform of claim 1, wherein, when the worker support proposal that satisfies a worker match condition of a specific worker request proposal input from the specific demander account does not exist in the worker support proposal DB, the worker match management module transmits a modification proposal recommendation message for the worker match condition of the specific worker request proposal to the specific demander account, or
when the worker request proposal that satisfies the worker match condition of a specific worker support proposal input from the specific performer account does not exist in the worker request proposal DB, the worker match management module transmits a modification proposal recommendation message for the worker match condition of the specific worker support proposal to the specific performer account.

11: The time donation bank platform of claim 1, wherein, when performer lifetime history information and demander lifetime history information registered in a lifetime history information DB are updated, a donation history management module transmits the updated performer lifetime history information and demander lifetime history information to the corresponding performer account and demander account.

12: A time donation method comprising:
generating an account, wherein a user account comprising a donation receiver account, a demander account, and a performer account is generated according to user information input from a user terminal by a user account management module, and registered in an account information DB;
determining a donation, wherein donation-related information input from the performer account is registered in a lifetime history information DB corresponding to the performer account by a donation history management module;
requesting a worker, wherein information related to a worker request proposal input from the demander account is registered in a worker request proposal DB by a worker request proposal management module;
supporting a worker, wherein information related to a worker support proposal input from the performer account is registered in a worker support proposal DB by a worker support proposal management module;
matching the worker, wherein worker request proposal information registered in the worker request proposal DB and worker support proposal information registered in the worker support proposal DB are analyzed, compared, and processed by a worker match management module to match each other with a worker match whenever the worker request proposal is registered in the worker request proposal DB or the worker support proposal is registered in the worker support proposal DB;
notifying the worker match, wherein worker match success information or worker match failure information each registered in a worker match DB is transmitted to a corresponding specific performer account and a specific demander account after the worker match success information is registered in the worker match DB when the worker match is successful, and the worker match failure information is registered in the worker match DB when the worker match has failed by the worker match management module; and
executing the donation, wherein remittance to one or more of a corresponding financial institution of a specific performer account user, a corresponding financial institution of a donation receiver account user listed in the donation-related information, and a TDB donation account is managed by distributing a preset wage remitted from a specific demander account user by a donation time distribution and the management module according to the donation-related information input by the specific performer account user when worker execution information indicating that the specific performer account user has provided the worker to the specific demander account user is input from one or more of the specific demander account and the specific performer account to which the worker match information is transmitted, and remittance management is performed by transmitting financial transaction information for remittance when the preset wage is remitted from the demander account user to the cooperative financial institutions, the financial transaction information comprising amounts distributed to cooperative financial institutions at a predetermined rate according to the donation-related information and one or more pieces of the following information of financial institutions to which the distributed amounts is to be deposited: information of the corresponding financial institution of the performer account user, information of the corresponding financial institution of the donation receiver account user, and information of the TDB donation account.

13: The time donation method of claim 12, further comprising:
receiving new donation history information and the new job provision history information generated by the donation time distribution and management module in the executing of the donation;
generating, by the donation history management module, time donation history information in which support time of the specific performer account user is converted into donation time for other people and donation time for oneself according to the new donation history information, generating new performer lifetime history information comprising donation amount accumulated up to the present time and the time donation history information for each donation receiver, or generating demander lifetime history information of the specific demander account user according to the new job provision history information; and
managing donation history, the managing of the donation history comprising updating, by the donation history management module, the generated performer lifetime history information and the demander lifetime history information in the lifetime history information DB and transmitting the modified lifetime history information to the specific performer account and the demander account.

14: The time donation method of claim 12, wherein the matching of the worker comprises:
comparing and analyzing whether or not there is the worker support proposal that satisfies a worker match condition of a specific worker request proposal by searching the worker support proposal DB by the worker match management module when the specific worker request proposal input from the specific demander account by the worker request proposal management module is registered in the worker request proposal DB;
transmitting one or more appropriate worker support proposals that satisfies the worker match condition to the specific demander account by the worker match management module; and
determining an appropriate worker support proposal input from the specific demander account as an optimal worker support proposal by the worker match management module, generating the worker match reservation information in which the specific worker request proposal and the optimal worker support proposal are paired, registering the worker match reservation information in the worker match DB, and then transmitting the worker match reservation information to the specific demander account and the specific performer account to which the optimal worker support proposal is input, or
the matching of the worker comprises:
comparing and analyzing whether or not there is the worker request proposal that satisfies the worker match condition of a specific worker support proposal by searching the worker request proposal DB by the worker match management module when the specific worker support proposal input from the specific performer account by the worker support proposal management module is registered in the worker support proposal DB;
transmitting one or more appropriate worker request proposals that satisfies the worker match condition to the specific performer account by the worker match management module; and
determining an appropriate worker request proposal input from the specific performer account as an optimal worker request proposal by the worker match management module, generating worker match reservation information in which the specific worker support proposal and the optimal worker request proposal are paired, registering the worker match reservation information in the worker match DB, and then transmitting the worker match reservation information to the specific performer account and the specific demander account to which the optimal worker request proposal is input, and
the matching of the worker further comprises:
attaching a worker match reservation tag, by the worker request proposal management module and the worker support proposal management module, to the specific worker request proposal and the optimal worker support proposal or the specific worker support proposal and the optimal worker request proposal, which constitute the worker match reservation information transmitted to the specific demander account and the specific performer account; and
modifying and registering the proposals in the worker request proposal DB and the worker support proposal DB.

15: The time donation method of claim 12, wherein the donation-related information comprises:
donation rate information for the wage obtained when worker provision is completed;
donation plan information comprising donation receiver information; and
one or more pieces of information of the financial institutions to which the amounts distributed according to the donation plan information is transferred: information of the performer account user, information of the financial institution of the donation receiver account user, and information of the TDB donation account,
donation history information comprises donation amount for each donation receiver and time donation history information in which support time of the performer account user up to the present time is converted into donation time for other people and donation time for oneself according to the donation rate information,
the support time of the performer account user is provided with 2 dona per support hour each time when a piece of worker execution completion information is registered in the worker match DB,
the donation rate information is able to determine rates such that a minimum donation rate is 5% of a wage and a maximum donation rate is 100% of the wage, and
the time donation history information is registered and managed cumulatively so that 2 dona is given per support hour for a piece of the registered worker execution completion information, all 2 dona are given to an item of donation time for other people when the donation rate information has the maximum donation rate of 100%, and 1 dona is given to the item of donation time for other people and 1 dona is given to an item of donation time for oneself when the maximum donation rate is in a range from greater than or equal to 5% to less than 100%.

16: The time donation method of claim 15, further comprising:
issuing a donation confirmation document comprising:
registering, by the donation history management module, confirmation document issuance request information in the lifetime history information DB according to the confirmation document issuance request information for time donation activity input from any one or more of the performer account and the demander account;
searching, by the donation history management module, performer lifetime history information and demander lifetime history information of one or more of the specific performer account and demander account corresponding to the confirmation document issuance request information, and transmitting the confirmation document issuance request information to the searched specific donation receiver account; and
registering, by the donation history management module, a confirmation document of the time donation activity in the lifetime history information DB when the confirmation document of the time donation activity is input from the donation receiver account, and then transmitting the confirmation document issuance request information to the specific performer account and demander account to which the information is input.

17: The time donation method of claim 12, wherein the notifying of the worker match comprises:
generating the worker match success information, registering the worker match success information in the worker match DB when a wage deposit signal in which a wage included in a specific worker request proposal is deposited within a preset time is input from the specific demander account to which the worker match management module has transmitted worker match reservation information, and transmitting the worker match success information to the specific demander account and the specific performer account; and
changing, to a worker match success tag, a worker match reservation tag attached to each of proposals including the specific worker request proposal and an optimal worker support proposal or a specific worker support proposal and an optimal worker request proposal, which constitute the worker match success information, and modifying and registering the proposals in the worker request proposal DB and the worker support proposal DB, respectively, or
the notifying of the worker match comprises:
generating the worker match failure information, registering the worker match failure information in the worker match DB when the wage deposit signal in which the wage included in the specific worker request proposal is deposited within the preset time is not input from the specific demander account to which the worker match management module has transmitted the worker match reservation information, and transmitting the worker match failure information to the specific demander account and the specific performer account; and
changing, to a worker match failure tag, the worker match reservation tag attached to each of proposals including the specific worker request proposal and the optimal worker support proposal or the specific worker support proposal and the optimal worker request proposal, which constitute the worker match failure information, and modifying and registering the proposals in the worker request proposal DB and the worker support proposal DB, respectively.

18: The time donation method of claim 17, wherein, when the worker match reservation tag is changed to the worker match failure tag by the worker request proposal management module and the worker support proposal management module and is modified and registered in the worker request proposal DB and the worker support proposal DB, the matching of the worker is re-performed for the specific worker request proposal or the specific worker support proposal, which constitute the worker match failure information.

19: The time donation method of claim 12, wherein the matching of the worker further comprises:
transmitting a modification proposal recommendation message for a worker match condition of a specific worker request proposal to the specific demander account by the worker match management module when the worker support proposal that satisfies the worker match condition of the specific worker request proposal input from the specific demander account does not exist in the worker support proposal DB, or transmitting the modification proposal recommendation message for the worker match condition of a specific worker support proposal to the specific performer account by the worker match management module when a worker request proposal that satisfies the worker match condition of the specific worker support proposal input from the specific performer account does not exist in the worker request proposal DB.

20: An application for time donation activity of claim 1, wherein the application for the time donation activity is installed on a user terminal connected to a time donation bank platform in order for time donation activity information of an account user generated in the time donation bank platform to be transmittable in both directions, whereby the application for the time donation activity is executed so that the account user is able to recognize input and output of the time donation activity information, the input and output being performed through the time donation bank platform.

21. (canceled)
